(19) United States
(12) Patent Application Publication
(10) Pub. No.: US 2024/0012931 A1
(43) Pub. Date: Jan. 11, 2024

(54) CONSTRAINING APPLICATION WORKLOADS USING DATA COMPLIANCE RULES

(71) Applicant: Cisco Technology, Inc., San Jose, CA (US)

(72) Inventors: Marcelo Yannuzzi, Vufflens-La-Ville (CH); Hervé MUYAL, Gland (CH); Jean Andrei DIACONU, Gaillard (FR); Frank BROCKNERS, köln (DE); Carlos GONCALVES PEREIRA, Carlsbad, CA (US)

(21) Appl. No.: 17/859,715

(22) Filed: Jul. 7, 2022

(51) Int. Cl. G06F 21/62; G06F 21/51

(52) U.S. Cl. CPC G06F 21/6245; G06F 21/51

(57) ABSTRACT

In one embodiment, a device determines a category of sensitive data processed by an application, based on annotations embedded into programming code of the application and protection bindings, which associate the category of sensitive data with one or more data types used by the application. The device computes, based on one or more data compliance constraints for the category of sensitive data, a set of one or more execution constraints for the application. The device identifies target infrastructure to execute a workload of the application that satisfies the set of one or more execution constraints. The device causes a deployment of the workload of the application for execution by the target infrastructure.

### TECHNICAL FIELD

The present disclosure relates generally to constraining application workloads using data compliance rules.

### BACKGROUND

Applications operate by handling data. For instance, executing an application can involve the storage, communication, processing, etc. of various types of data. The various types of data may include data whose handling is subject to various regulations. For example, data handling regulations at national, federal, state, industry, and/or organizational levels may be applicable to the data handled by an application.

Data compliance has, thus far, been an afterthought during the application development lifecycle. Given the amount of data compliance regulations, their scope, and complexity, software developers and/or vendors are neither expected to have knowledge, nor to programmatically deal with, the intricacies of specific data regulations when developing an application. As such, data compliance is addressed without programmatic guidance from those with the knowledge of the types of data handled by the application and the regulations applicable thereto. Instead, data compliance is generally limited to post hoc supervision of data handling. However, with violations of data compliance regulations increasingly resulting in substantial fines and penalties, the data compliance as an afterthought model is no longer viable.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for integrating data compliance as code;

FIGS. 4A-4B illustrate an example architecture for integrating data compliance as code and protection bindings;

FIG. 5 illustrates an example architecture for constraining application workloads using data compliance rules;

FIGS. 6A-6B illustrate an example architecture for constraining application workloads using data compliance rules; and

FIG. 7 illustrates an example simplified procedure for constraining application workloads using data compliance rules.

### DESCRIPTION OF EXAMPLE EMBODIMENTS

### Overview

According to one or more embodiments of the disclosure a device determines a category of sensitive data processed by an application, based on annotations embedded into programming code of the application and protection bindings, which associate the category of sensitive data with one or more data types used by the application. The device computes, based on one or more data compliance constraints for the category of sensitive data, a set of one or more execution constraints for the application. The device identifies target infrastructure to execute a workload of the application that satisfies the set of one or more execution constraints. The device causes a deployment of the workload of the application for execution by the target infrastructure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

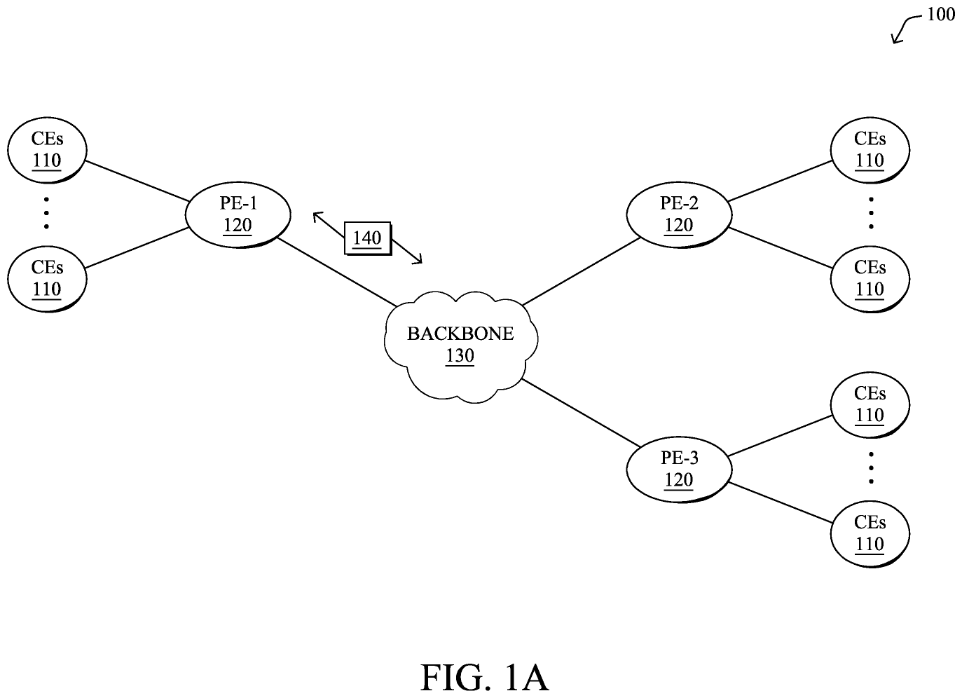

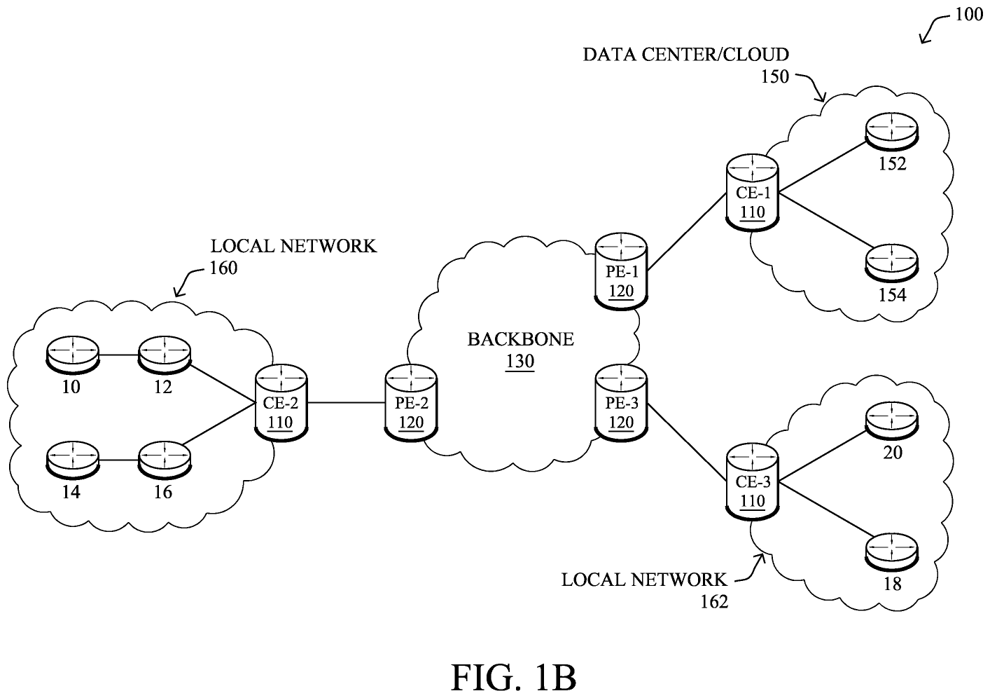

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

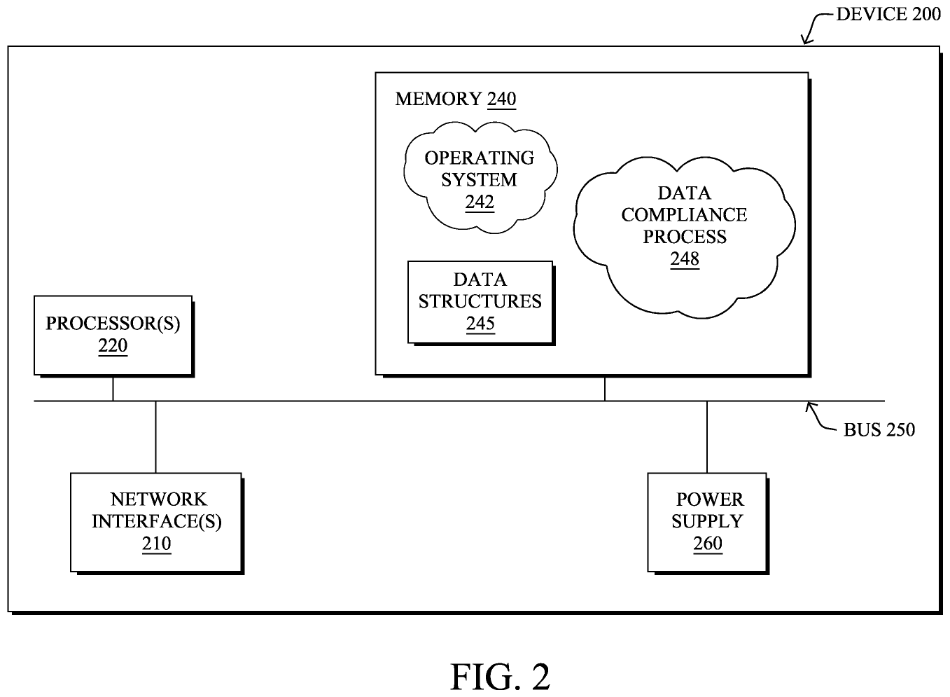

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise data compliance process 248, as described herein, any of which may alternatively be located within individual network interfaces.

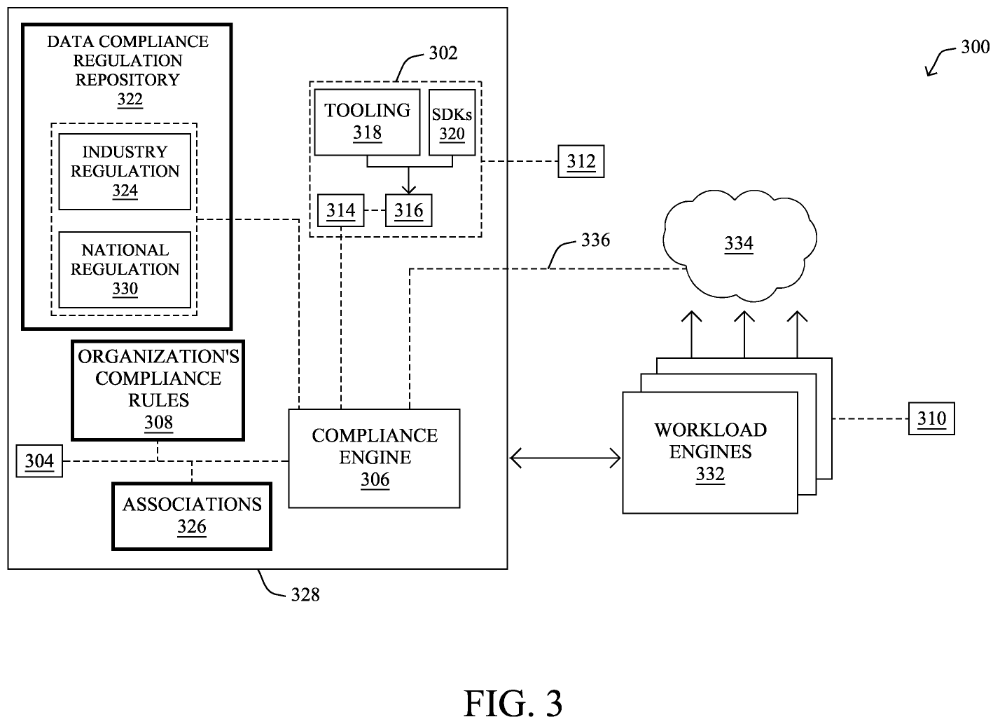

FIG. 3 illustrates an example architecture 300 for data compliance, according to various embodiments. The architecture 300 may include a data compliance process 328. Data compliance process 328 may be utilized to provide configuration, observability, and enforcement of data compliance rules. Data compliance process 328 may accomplish these functions utilizing Data Compliance as Code (DCaC).

DCaC may include integrating a data compliance mechanism into the program code of the application. For example, data compliance process 328 may be utilized to build data compliance into the application development process, supported by automated code annotations, bindings between such annotations and categories of sensitive data, and controls at code, build, and pre-deploy time. Data compliance process 328 may provide a mechanism whereby application developers proactively assist data teams, application managers, and legal departments with data compliance, while ensuring that developers may remain oblivious to specific regulations, data related obligations, or compliance requirements that organizations might have across different regions.

For example, data compliance process 328 may include data annotating process 302. Data annotating process 302 may facilitate application developer 312 automatically adding metadata to program code of an application 316 during the development of the application 316. In various embodiments, this may be performed by automated annotations of data fields in the program code and by the creation of references to such annotations at code-build time. These references to annotated code may be automatically rendered in the form of machine-readable data manifest 314.

More specifically, data annotating process 302 may provide a mechanism for automated annotations of the program code of application 316, including classes, application programming interfaces (APIs), and the resulting data at code/build time (e.g., by implementing a Low-Code/No-Code approach supported by software development kits (SDKs) 320 and tooling 318). Application developers may utilize SDKs 320 and tooling 318 to automatically label data topics, data producers, data consumers, data processors, data holders, etc. For instance, developers may label certain data by annotating it with a data type identifier. For example, a developer may annotate certain data as “protected-type-1,” or other data as “protected-type-2,” and so on.

SDKs 320 in data annotating process 302 may provide a set of predefined data types out-of-the-box, including associations by default to specific categories of sensitive data. Sensitive data may include a type of data that may be considered personal, private, sensitive, confidential, protected, secret, restricted, personally identifiable information (PII), etc. In some examples, sensitive data may include data that is subject to regulation. For example, Table 1 lists examples of predefined protected data types and default associations to some examples of categories of sensitive data.

TABLE 1

| PROTECTED DATA TYPE | DEFAULT ASSOCIATION |
|---|---|
| protected-type-1 | Customer PII |
| protected-type-2 | Employee PII |
| . . . | . . . |
| protected-type-23 | Patient Analysis Results |
| protected-type-41 | Sales Confidential |
| . . . | . . . |
| protected-type-56 | Restricted HR |
| . . . | . . . |
| unprotected | NA |

A list of the associations, such as the example illustrated in Table 1, may provide associations by default to several categories of sensitive data, including but not limited to PII, confidential, restricted, and unprotected data. In some embodiments, the set of predefined protected data types might be standardized or rely on an existing taxonomy.

SDKs 320 in data annotating process 302 may also provide a mechanism to define and use custom data types in annotating program data of the application 316. For example, custom data types may be utilized, which identify protected data types that are not covered by any of those available by default in SDKs 320. For example, “custom-type-1” might be a custom data type associated to a category of sensitive data such as “Restricted Employee Poll.” In various embodiments, the generation and/or insertion of the annotations into the program code of the application 316 may be accomplished by an automated process (e.g., a programmatic identification of data of a particular data type triggering an automated insertion of an annotation of the data as the particular data type, etc.), a partially automated process (e.g., a programmatic flagging of data of a particular data type with a supervised or manual annotation of the data as the particular data type, etc.), and/or a manual process (e.g., a manual flagging of data of a particular data type and/or a manual annotation of the data as the particular data type, etc.).

In various embodiments, associations between protected data types and categories of sensitive data may be assigned and/or instrumented by different organizations and at different moments in time. In some cases, the association between protected data types and categories of sensitive data may be assigned by application developers 312 at code/build time. This might be the case when the team of application developers 312 is part of, or develops for, the organization that may use or manage the application 316. In such cases, the team of application developers 312 might have sufficient knowledge about the data and their use, so that they may either use the associations provided by default or create custom ones.

In additional instances, application developers 312 of application 316 and/or the users of the application 316 might belong to different organizations. For example, this may be the case when application developers 312 are a DevSecOps team that develops an application 316 that may be used across different organizations, industries, etc. In such cases, application developers 312 may be unaware of the categories of data that should be assigned by a data team and/or application manager 304 in another organization (e.g., precisely what data is confidential and what data is not with respect to that organization and its use of the application 316). In these instances, application developers 312 may leverage SDKs 320 and tooling 318 to approach data labeling and association in a manner that sidesteps the knowledge deficit while still instilling the functionality. For example, the application developers 312 may leverage SDKs 320 and tooling 318 to automatically add the different classes of protected data type at code build time (e.g., utilizing predefined protected and custom data types). Additionally, or alternatively, the application developers 312 may leverage SDKs 320 and tooling 318 to automatically insert references in the form of machine-readable descriptions for the protected data types that may be used to generate data manifest 314 bound to application 316 at build time.

The protected data type annotations and their corresponding references may be utilized by a data team and/or application manager 304 in another organization to select and/or create automated associations 326 between categories of annotated data in the application 316 (e.g., metadata provided by application developers 312) and specific categories of sensitive data (e.g., personal data, private data, sensitive data, confidential data, protected data, secret data, restricted data, PII, etc.). For instance, each protected data type might be bonded to a class of tokens (e.g., JSON Web Tokens with a specific scope), which in turn might represent different categories of sensitive data for a data team and/or application manager 304.

In a specific example, an API call for application 316 may be labeled by application developers 312 with a data type identifier such as “custom-type-7” at code/build time. The “custom-type-7” labeled API call may attempt to access certain data using its bound token (e.g., “Token 7”) with a scope defined by, for example, a data team and/or application manager 304 before application 316 was deployed. From the data team and/or application manager 304 perspective, the attempt to access this data may translate to a request to access, for instance, “Confidential Partner” data. As such, the data type labels, and their associations may be utilized as an automated data mapping between the programmatic operations of application 316 and the sensitive data implicated in those operations. In various embodiments, these associations and functionalities may be supported by compliance engine 306 based on the selection, configuration, and automation of data compliance rules before application 316 is deployed and/or post-deployment.

In some examples, application developers 312, which again may be a DevSecOps team, might opt for a hybrid approach to generating these associations. For example, this may be the case when making some custom associations between data types and categories of sensitive data or using those predefined in the system (e.g., “protected-type-1” to “Customer PII”) might not only be trivial for the application developers 312 but also may facilitate the task of a data team and/or application manager 304 in defining associations. However, other associations might not be apparent to application developers 312. Hence, certain data in application 316 may be labeled as “protected types” along with their corresponding machine-readable descriptions in data manifest 314, though they may remain unassigned to a specific category of sensitive data, so they can be associates later by a data team and/or application manager 304 before the application is deployed, or by an automated data lineage, classification, and tagging process at run time (e.g., during the testing phase, that is, before the application is deployed in production).

In some embodiments, a data team and/or application manager 304 may be provided with a mechanism to change the associations created by application developers 312 or even associate more than one category of sensitive data to a given data type (e.g., a data team and/or application manager 304 may associate certain data with both “Employee PII” and “Confidential Data”). Hence, two categories of data compliance policies (e.g., one for “Employee PII” and another for “Confidential Data”) may apply and restrict even further the access to this category of data. In general, a data team and/or application manager 304 may be able to Create, Read, Update, or Delete (CRUD) any association between the metadata provided by application developers 312 and categories of sensitive data.

In various embodiments, a data team and/or application manager 304 may proactively create a set of custom data types. A data team and/or application manager 304 may provide the set of custom data types to application developers 312. Application developers 312 may then utilize the set of custom data types so that application 316 is annotated at development based on guidelines (e.g., the set of custom data types, etc.) provided beforehand by the data team and/or application manager 304.

In additional embodiments, application developers 312 and a data team and/or application manager 304 may collaborate to annotate application 316. For example, application developers 312 and a data team and/or application manager 304 may iterate in the annotation and association processing in an agile manner. For example, the iteration may be performed as part of a continuous integration/continuous delivery (CI/CD) pipeline (e.g., at testing, staging, and production).

In some examples, application 316 may be composed of several services developed with different programming languages. Therefore, application 316 may utilize different SDKs 320. In some instances, the annotation methods and terminology applied to application 316 may vary depending on the programming language (e.g., usually referred to as attributes in C#, decorators in Python, annotations in Golang, etc.). In such cases, tooling 318 of data annotating process 302 may examine the different predefined and custom data types used with different SDKs 320, perform checks, and ensure consistency in the annotations and enumeration across the different services at build time. For example, these consistency checks may ensure that a given “custom-type-X” data type identifier represents the same type of data across services programmed using different programming languages even if they were programmed by different developers. Overall, the data annotating process 302 may provide different degrees of freedom to application developers 312, data teams and/or application managers 304, and the number of protected data types used, and their corresponding associations may vary depending on the type of application 316.

Data annotating process 302 may, as described above, be utilized in generating automated data references. Specifically, data annotating process 302 may automatically render a data manifest 314 bonded to application 316 at build time. Data manifest 314 may provide machine-readable descriptions of the predefined and/or custom data types used by application 316. A combination of SDKs 320 and tooling 318 may facilitate the instrumentation and automation of the program code at build time, including the automated rendering of data manifest 314. In some cases, application 316 may be composed of various containers. Each container may be built and packaged with its own data manifest, such that the final data manifest rendered for application 316 may be a composition of the individual data manifests. In some cases, application 316 may include dependencies on external services, such as a MySQL database. Such dependencies may be captured as a dependency manifest. Data fed, processed, retained, or retrieved from these external services may also be annotated and automatically captured in application 316 data manifest 314.

Data annotating process 302 may, as described above, be utilized for decoupling data compliance from the business logic of application 316. For example, SDKs 320 and tooling 318 of data annotating process 302 may provide automated mechanisms for decoupling the configuration, observability, and enforcement of data compliance rules from the business logic of application 316. In some instances, application 316 may be a cloud/edge native application, which may be implemented as a set of workloads composing a service mesh. The decoupling of data compliance from the business logic may be especially relevant for applications of this type, as geographically dispersed and/or variably deployed workloads may implicate increased data compliance complexity.

Various possible embodiments for decoupling data compliance from the business logic of application 316 may be utilized. For instance, a sidecar model, where the services that implement the business logic of application 316 are deployed together with sidecar proxies associated to each of those services, may be utilized. The sidecar proxies may be utilized to enforce horizontal functions that are independent of the business logic, such as routing, security, load balancing, telemetry, retries, etc. As such, the sidecars may be well-positioned to decouple, observe, and control data compliance. For example, a combination of distributed data compliance controllers and sidecar proxies may be used to configure, observe, and enforce data compliance rules across different geographies, and distributed multi-cloud and edge infrastructures 334.

Instead of, or in addition to, using sidecars, various embodiments may use client libraries, daemons working in tandem with the application-specific services, or sandboxed programs in the OS kernel, e.g., using the Extended Berkeley Packet Filter (eBPF). Further embodiments may use an agentless approach or embed such functionality in Kubernetes itself. In any case, the functionality introduced herein may enable the portability and reuse of observability and enforcement of data compliance functions across not only different applications but also cloud and edge environments.

The above-described data annotating process 302 may yield a portable annotated application 316 that is geared with built-in annotations for different types of protected data. In addition, the yielded annotated application 316 may be structured to operate while remaining agnostic of any state, country, industry, organization-specific regulation and/or data policy requirements that a data team and/or application manager 304 might have. As a result, data annotating process 302 may be leveraged as a new model of building applications including DCaC by not only data teams and/or application managers 304, but also software as a service (SaaS) providers and others.

Data compliance process 328 may provide configuration, observability, and enforcement of data compliance rules. As described above, associations 326 between categories of annotated data in application 316 and specific categories of sensitive data may be instrumented prior to a deployment of application 316. The associations 326 may be used to control the processing and use of data during and after the deployment of application 316. More specifically, compliance engine 306 may utilize associations 326 together with current data compliance regulations governing data handling in each region where application 316 may be used, as well as a specific organization's compliance rules 308 for/while using application 316, to enforce compliance with them. Such controls may apply to data access requests, data storage and retention policies, data processing requirements, etc. of application 316 both at deploy and execution time, etc.

To this end, data compliance process 328 may include data compliance regulation repository 322. Data compliance regulation repository 322 may provide a repository of data compliance rules. For example, data compliance regulation repository 322 may include a repository of industry regulations 324 which may be applicable to the use of application 316. For example, with respect to instances where application 316 is used by a healthcare provider, data compliance regulation repository 322 may include industry regulations 324 such as Health Insurance Portability and Accountability Act of 1996 (HIPAA) regulations applicable to handling of data in the healthcare industry. In other examples, data compliance regulation repository 322 may include a repository of national regulations 330 which may be applicable to the use of application 316. For example, with respect to instances where application 316 is based in a member state of the E.U., data compliance regulation repository 322 may include national regulations 330 such as the GDPR applicable to handling of data in the E.U.

The data compliance regulations included in data compliance regulation repository 322 may be consumed by a data team and/or application manager 304 as a service (aaS). Data compliance regulation repository 322 may support input, expression, collection, approval, visualization, and/or use of data compliance policies covering multiple categories of rules. For example, data compliance regulation repository 322 may store data compliance policies that are specific to an industry, those that may apply at a national, multi-national, federal, state, and industry levels, etc. For instance, an organization (e.g., a multi-national company) may leverage a data compliance regulation repository 322 service of a data compliance process 328 and utilize the regulations already available in data compliance regulation repository 322, which may cover regulations across several industries and countries out-of-the-box. An organization may select the target state, country or region, the industry if needed, and select the data compliance regulations that may be applicable at the organizational level (e.g., organization's compliance rules 308).

Compliance engine 306 may offer APIs and a user-friendly user interface (UI) through which a data team and/or application manager 304 may select and define data compliance requirements. For instance, if application 316, which handles Customer PII data, needs to be deployed in British Columbia, Canada, a data team and/or application manager 304 may simply select “Customer PII→Apply Local Regulation” to constrain the processing, storage, retention, and access to Customer PII data according to the regulations in British Columbia as retrieved from data compliance regulation repository 322. To this end, compliance engine 306 may compute and handle the resulting constraints that apply to Customer PII data in British Columbia transparently to data teams and/or application managers 304. More specifically, the set of data compliance constraints may be captured in a machine-readable format from data compliance regulation repository 322, and therefore, used by compliance engine 306 programmatically.

In some examples, compliance engine 306 may be utilized as a pluggable module working in tandem with one or more workload engines 332, such as Cisco Intersight or any automation tool offered by a hyperscaler, or other cloud and edge providers. Workload engines 332 may manage the deployment of application 316, subject to the rules and constraints provided by compliance engine 306.

In various embodiments, compliance engine 306 may operate either in a push or a pull model. For instance, in a pull model, a workload engine 332 may receive a request to deploy application 316 in a given region (e.g., a request from a site reliability engineering (SRE) and/or information technology (IT) team 310). In such a case, workload engine 332 may issue a request to compliance engine 306, to compute and return data compliance rules and constraints that must be applied for their specific deployment.

Alternatively, in a push model, a data team and/or application manager 304 may select the compliance rules required and a declarative intent for application deployment may be issued from compliance engine 306 to one or more workload engines 332. Such deployments may involve multi-cluster service meshes, which may run across multi-cloud and edge infrastructures 334. In various embodiments, the above-described sidecar proxies in the service mesh may not only provide monitoring and observability of data compliance to compliance engine 306 but also may receive configuration and compliance updates in real-time 336. In additional embodiments, the same functionality may be implemented utilizing client libraries, daemons, eBPF, an agentless approach, or Kubernetes itself. In addition, some embodiments may support the techniques described herein without utilizing a service mesh.

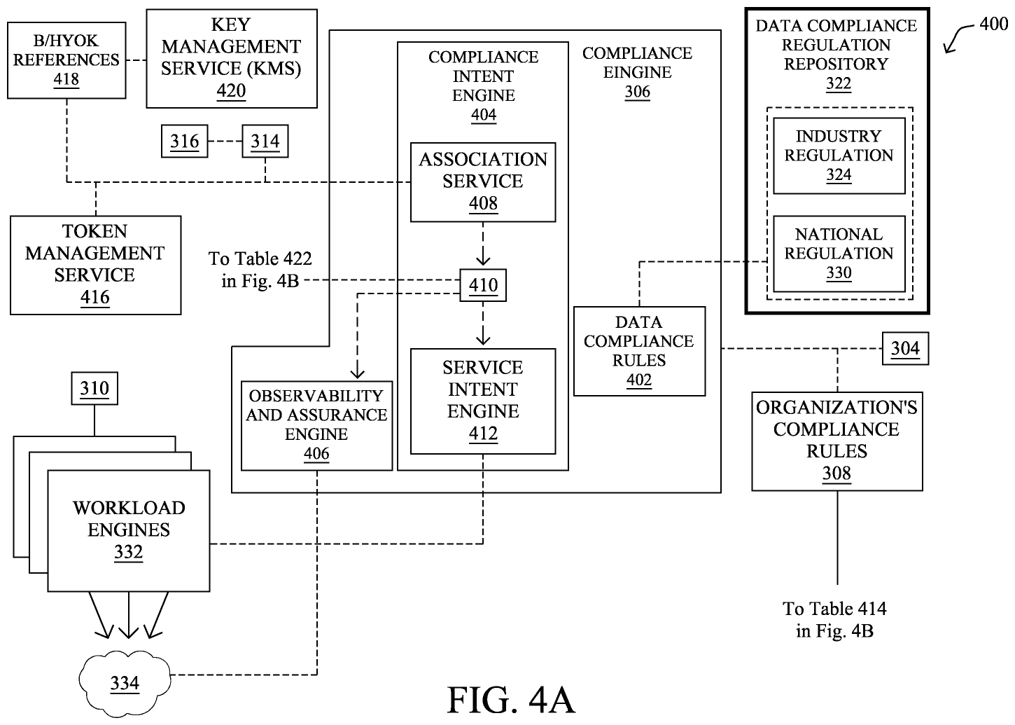

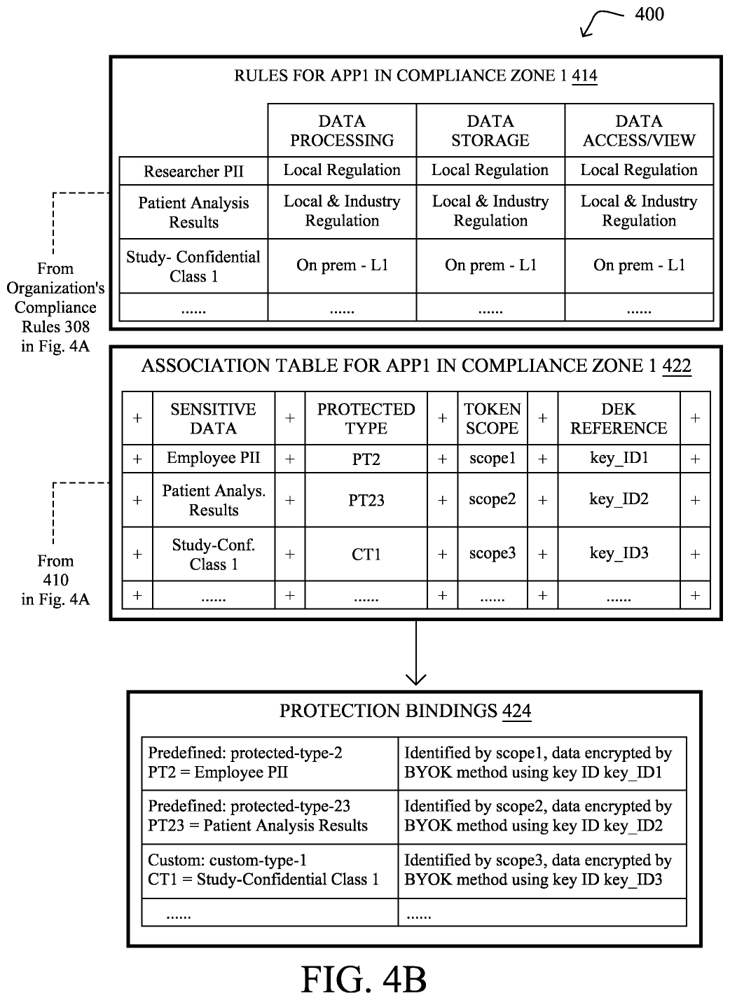

FIGS. 4A-4B illustrate an example architecture 400 for data compliance and protection bindings according to various embodiments. Architecture 400 may be utilized to deliver DCaC. For example, architecture 400 may include compliance engine 306. Compliance engine 306 may include data compliance rules module 402, compliance intent engine 404, and/or observability and assurance engine 406.

Data compliance rules module 402 may compute compliance constraints based on a combination of inputs. For example, the constraints may be computed based on a combination of inputs including the target state, country, or multi-country region for an application, the industry the application is being utilized within, and/or the compliance rules required by an organization using the application.

Compliance intent engine 404 may include an association service 408. Association service 408 may manage a set of association tables 410. Association service 408 may include functionality to allow a data team and/or application manager 304 to select, configure, and create the associations (e.g., associations 326 from FIG. 3) and store them in the form of protection bindings 424 in association tables 410 (e.g., populated association table 422 and its associated protection bindings 424 provide a non-limiting specific example of one such association table). The protection bindings 424 may define a data handling scope bonded to the association between a data type and its associated category of sensitive data. The data handling scope may be an indication of how data will be handled by the application (e.g., applicable tokens, token scopes, encryption keys, etc.). The protection bindings 424, stored in populated association table 422 may be created and/or maintained by compliance engine 306. The protection bindings 424 may not be reinserted into the program code but rather maintained by compliance engine 306 since protection bindings 424 may be subject to changes over time (e.g., the scopes might change, encryption keys may be rotated, etc.) and keeping the protection bindings 424 outside of the program code may prevent these changes from affecting the program code.

Additionally, compliance intent engine 404 may include a service intent engine 412. Service intent engine 412 may interface with workload engines 332. Service intent engine 412 may either receive and/or process data compliance requests from workload engines 332 (e.g., pull model) or create and/or issue declarative intents encoding a deployment request to workload engines 332 (e.g., push model).

Observability and assurance engine 406 may receive telemetry data from services deployed in the field (e.g., from a service mesh deployed across multi-cloud and edge infrastructures 334). In addition, observability and assurance engine 406 may push data compliance configurations and data traffic filters in real-time 336 out to workloads deployed in the multi-cloud and edge infrastructures 334.

To populate association tables 410 and create protection bindings 424, association service 408 may obtain inputs defining the associations of the protected data types and/or their data handling scopes. For example, for each annotated application 316, association service 408 may obtain data manifests 314 describing the set of predefined and custom protected data types handled by annotated applications 316 and potential associations already made by application developers (e.g., application developer 312 in FIG. 3).

Additionally, association service 408 may obtain data handling scopes to be bonded to individual associations between given data types and their associated category of sensitive data. For example, association service 408 may obtain, as an input, categories of tokens and corresponding scopes that may be associated with each of the protected data types used in the annotated classes and methods that compose the annotated application 316. Such tokens may be defined and/or obtained from external token management service 416 (e.g., from OKTA).

Further, association service 408 may obtain, as an input, identifiers of encryption keys. The encryption keys may be those keys associated with each of the protected data types used in the annotated classes and methods that compose annotated applications 316. For example, different categories of sensitive data may be encrypted utilizing techniques such as bring your own key (BYOK) or hold your own key (HYOK). The encryption key identifiers (ID) may be defined or obtained from external encryption key service 418, which may extract encryption key IDs. External encryption key service 418 may interface with key management service (KMS) 420 and may create references (e.g., key IDs) to encryption keys stored and managed by KMS 420. In this manner, the keys may not be managed by association service 408, but instead may remain secure with KMS 420.

This set of inputs may be utilized by association service 408 to populate association tables 410. In some examples, there may be one association table populated per annotated application 316 and/or per data compliance zone (e.g., a geographical area where the application is deployed, etc.). A populated association table 422 may include the automatically associated annotated data types (e.g., protected data type labels), with categories of sensitive data (e.g., encoded in the form of tokens with specific scopes as illustrated in populated association table 422), along with pointers to the encryption keys used for each category of protected data (e.g., key IDs).

Compliance engine 306 may handle one populated association table 422 per compliance zone for each annotated application 316. In some embodiments, populated association table 422 may be extended to include columns denoting API paths to access the data resources. In some cases, the paths may explicitly embed the protected data types used by the application developers. In addition, the tokens, scopes, and key IDs may be renewed and dynamically updated in populated association table 422 depending on their validity and/or expiration time. Populated association table 422 may also manage more advanced associations, including m:n bindings (e.g., two or more protected data types might be associated to a single token/scope class).

Once association tables 410 are defined and/or populated, a data team and/or application manager 304 may select the organization's compliance rules 308. Organization's compliance rules 308 may include data compliance rules (e.g., data compliance rules 414) selected to be required for a specific annotated application 316 (e.g., “App 1”) that should be deployed in a specific geographical region (e.g., “Compliance Zone 1”).

For example, data compliance rules 414 may include constraints selected to be applied to each category of sensitive data (e.g., “Researcher PII,” “Patient Analysis Results,” “Study-Confidential Class 1,” etc.) within annotated application 316 “App 1”. Data compliance rules 414 may further specify the selected constraints associated with processing the category of sensitive data, storage, and retention of the category of sensitive data, and/or accessing or viewing of the category of sensitive data by the annotated application 316.

Data compliance rules 414 may be rules that may apply to a new annotated application 316 (e.g., “App 1”). In this example, application “App 1” may handle data about clinical trials of a new drug developed by a pharmaceutical company. Application “App 1” may collect and analyze data and provide insights about the new drug. In this example, the application “App 1” may support several categories of sensitive data.

For example, the application “App 1” may support the category of sensitive data “Researcher PII” data, which may include PII of the employee conducting one of the trials. In this example, the rule chosen may be one to restrict the processing, storage, retention, and access to the data according to a “local regulation.” For example, if the compliance zone where the application is going to be deployed is British Columbia, Canada, then this rule automatically constrains the location of workloads, the storage, and any attempt to access or view such data according to the regulation on PII in British Columbia, Canada. If the trials were instead to be conducted in New Delhi, India, the rule might be the same (e.g., applying a local regulation), but the resulting constraints yielded by compliance engine 306 will usually differ from those in British Columbia, Canada by virtue of the two locations having different data handling regulations.

Application “App 1” may also support the category of sensitive data “Patient Analysis Results” data. In this example, the rule chosen by a data team and/or application manager 304 may adhere to both the local and industry-specific regulation. In the examples of application “App 1,” the industry-specific regulation may include, for example, specific legislation constraining the processing, storage, retention, and access to patients' data with respect to clinical trials.

Application “App 1” may additionally support the category of sensitive data “Study-Confidential Class 1” data. This data type may be a custom protected data type that may be implemented to enable researchers to keep a specific category of data related to the clinical trials as highly confidential. In this example, the processing, retention, and access to the data may be constrained to a specific facility. For example, perhaps the processing, storage, retention, and access of the “Study-Confidential Class 1” data is constrained to the premises of a “Laboratory 1” associated with the clinical trial (e.g., “On prem-L1”).

Based on data compliance rules 414 input along with the corresponding protection bindings 424, data compliance rules module 402 may identify the implicated categories of sensitive data. For example, the three categories of sensitive data (e.g., “Employee PII,” “Patient Analysis Results,” and “Study-Confidential Class 1”) listed in data compliance rules 414, along with corresponding protection bindings 424 in populated association table 422 may be identified by data compliance rules module 402. These categories of sensitive data may be defined and/or used by a data team and/or application manager 304 and/or may have already been associated to specific predefined and custom protected data types, such as the ones shown in populated association table 422 and/or protection binding 424.

In addition, data compliance rules module 402 may identify the selected compliance requirements listed in data compliance rules 414. For example, data compliance rules module 402 may identify the compliance requirements specified for processing, storage, retention, and access for each of the categories of sensitive data as defined in data compliance rules 414.

Data compliance rules module 402 may compute the set of compliance constraints that apply to application “App 1” based on data compliance rules 414 and/or a compliance zone selected (e.g., a target country and industry for “App 1”). In some examples, the set of compliance constraints may be computed from, for example, industry regulations 324, national regulations 330, etc. obtained from data compliance regulation repository 322.

The output of data compliance rules module 402 (e.g., the computed set of compliance constraints for a category of sensitive data) may be processed by compliance intent engine 404. Compliance intent engine 404 may link the resulting constraints to the corresponding populated association table 422 and send this output to both observability and assurance engine 406 and service intent engine 412. As such, the compliance constraints may be linked to categories of sensitive data and/or their associated protected data types in the program code. Therefore, the compliance constraints may be linked to individual portions of the application code. For instance, the constraints may be linked to control a data transfer through an API call that was previously annotated by application developers 312 using the protected data types referenced in protection bindings 424, populated in association table 422, and constrained by data compliance rule module 402 according to data compliance rules 414.

In various embodiments, once a service mesh is deployed, a data consumer process may request access to a data resource through an API. This may be implemented using a GET method including a path containing the field “custom-type-1” (CT1), which, according to populated association table 422, represents the custom protected type “Study-Confidential Class 1”. The HTTP request may be transported and forwarded over mTLS across the sidecar proxies in the service mesh. The authorization header in the service mesh may carry “token 3” with a specific scope “scope 3,” as defined in populated association table 422. In this example, “scope 3” represents the category of sensitive data “Study-Confidential Class 1,” and the constraint in this case is that the data of that type must be retained on “prem Lab1.” To that end, service intent engine 412 may have requested and/or instructed a workload engine 332 to deploy the workloads handling “CT1” “on prem L1.” In turn, observability and assurance engine 406 may have configured data filters in the sidecar proxies to enforce access control. For instance, API calls using an authorization token with “scope 3” may be restricted to data consumers located “on prem L1.”

Compliance engine 306 may process more elaborate data compliance rules than simply those illustrated, including the selection of specific locations for processing, storage, retention, and access for each category of sensitive data. For instance, a data team and/or application manager 304 may choose a specific data center (e.g., where their data warehouse is hosted), a compliant public or edge zone, a compliant private cloud or edge site, combinations of these, etc. While some of these selections may be very specific, others might remain openly declarative, which a member of SRE/IT team 310 may translate into a specific infrastructure request for deploying the application, or some of the services that comprise the application.

Some of the tokenization mechanisms described herein may be externally handled, such as by an authorization server, which may potentially work in concert with a delegated authorization solution (e.g., OAuth 2.0/OpenID Connect), a single sign-on (SSO) solution, etc. In such scenarios, the specific categories of tokens and scopes references in association tables 410 may be obtained from external systems.

In addition to the tokenization mechanisms, a data team and/or application manager 304 may also select the user and/or process groups that may have access to the different categories of sensitive data (e.g., read only, read and write, or no access). Such groups may be managed using internal tools or they may be externally handled by an authorization service (e.g., OKTA). In some embodiments, the selection of token scopes and the access rights applied to user and/or process groups may be made jointly. These additional constraints may also be part of the data compliance rules and state maintained by data compliance rule module 402.

In an alternative embodiment, compliance engine 306 may also enable the use of third-party annotations and/or data catalogs (e.g., imported from external data classification and tagging systems, such as from Collibra, OneTrust, or others). In such cases, the protected types used in protection bindings 424, and populated in association table 422, may be comprised of a set of annotation labels (i.e., metadata) added by application developers 312 (e.g., PT2, PT23 and CT1 in FIGS. 4A-4B) as well as third-party labels provided by external systems.

As such, DCaC implemented through architecture 400 may provide two levels of decoupling. First, a decoupling between the annotations or metadata embedded in the program code of the application as provided by application developers 312 at code/build time and the categories of sensitive data that may be selected and associated by a data team and/or application manager 304 before the annotated application 316 is deployed. Second, a decoupling between the categories of sensitive data and the rules selected by a data team and/or application manager 304, and the specific data compliance regulation and data compliance constraints that may apply to a given industry and/or region.

Such an approach may facilitate application developers 312 proactively assisting a data team and/or application manager 304, while all of them are allowed to remain oblivious to the specificities and intricacies of the different data compliance regulations across the different industries and regions.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, the number of laws, regulations, and rules regarding the storage and use of certain types of data are continually increasing across the globe. For instance, the General Data Protection Regulation (GDPR) in Europe places strict regulations on how a user's personal data is collected and shared. These and other regulations have spawned independent efforts across several countries to ensure that online applications comply with specific data regulations at national, federal, or state level, and particularly, those that are cloud-based. This acceleration in data sovereignty regulations is posing complex challenges to the organizations that use or manage that data, since legal obligations and constraints vary from country to country. The challenge is even greater since data compliance requirements are often not limited to data sovereignty obligations. For example, depending on the type of an application, data compliance may demand the amalgamation of other regulations, such as industry-specific regulation (e.g., complying with HIPAA obligations in the healthcare industry in the United States), or organization-specific rules (e.g., on how to deal with confidential data).

In addition, applications are increasingly being developed as a set of distributed workloads that are deployed across heterogenous multi-cloud and edge infrastructures. Accordingly, organizations today face the challenge of ensuring that the location of their application workloads and the corresponding data processing across various public and private clouds and edge infrastructures complies with local data sovereignty obligations and other compliance rules in different geographical locations.

Constraining Application Workloads using Data Compliance Rules

The techniques herein introduce an approach that allows for application workloads to satisfy various data compliance requirements and ensure data sovereignty in an automated manner at pre-deploy and deploy time. More specifically, the techniques herein introduce a new approach enabling automated and attestable control on application workload placement (e.g., as part of a service mesh), subject to various data sovereignty and compliance rules, which may apply across different geographical locations, multi-cloud, and edge environments.

Illustratively, the techniques described herein may be performed by hardware, software, and/or firmware, such as in accordance with data compliance process 248, which may include computer executable instructions executed by the processor 220 (or independent processor of interfaces 210) to perform functions relating to the techniques described herein.

Specifically, according to various embodiments, a device determines a category of sensitive data processed by an application, based on annotations embedded into programming code of the application and protection bindings, which associate the category of sensitive data with one or more data types used by the application. The device computes, based on one or more data compliance constraints for the category of sensitive data, a set of one or more execution constraints for the application. The device identifies target infrastructure to execute a workload of the application that satisfies the set of one or more execution constraints. The device causes a deployment of the workload of the application for execution by the target infrastructure.

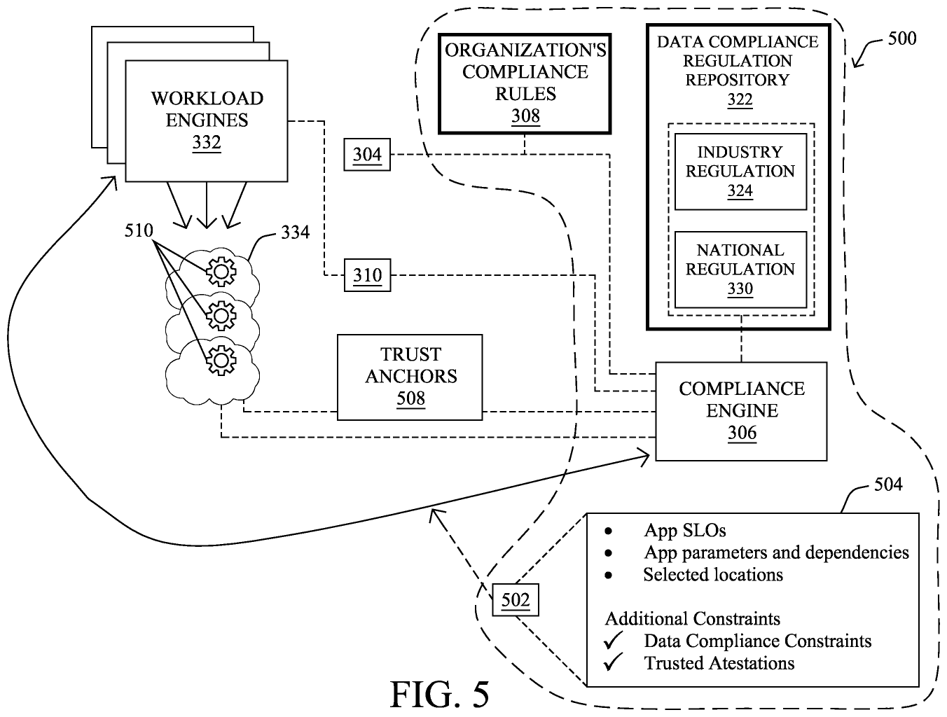

Operationally, and according to various embodiments described herein, FIG. 5 illustrates an example architecture 500 for constraining application workloads 510 using data compliance rules. Architecture 500 may include data compliance process 328. Data compliance process 328 may be executable to constrain application workloads 510 using data compliance rules through leveraging the DCaC model. Specifically, data compliance process 328 may be used to automatically control the location of application workloads 510 and their corresponding data processing in, for example, a heterogenous multi-cloud and/or edge infrastructure 334, subject to data sovereignty obligations and other compliance constraints at pre-deploy and deploy time.

Data compliance process 328 may include compliance engine 306. Compliance engine 306 may enable a data team and/or application manager 304 to enter and manage data compliance requirements of an organization. For instance, if an application that handles PII is to be deployed in Brazil, a data team and/or application manager 304 may simply select “PII→Local Regulation” to indicate to compliance engine 306 that an applicable local regulation regarding the handling of PII for the location where the application is to be deployed should be applied. Compliance engine 306, having determined that the application deployment is targeted to Brazil, may compute and handle the resulting constraints that apply to handling of PII in Brazil transparently to a data team and/or application manager 304. More specifically, the set of data compliance constraints applicable to the handling of PII in Brazil may be captured in a machine-readable manner, and therefore, may be used by compliance engine 306 programmatically.

In some examples, a data team and/or application manager 304 may not be required to directly enter that the local regulations specifically of Brazil must be applied to this application. Instead, they may be able to select the generic option of applying a local regulation and allowing the intelligence of data compliance process 328 to automatically identify Brazil as the target location and to automatically determine the appropriate constraints (e.g., those specific to Brazil). As such, this may facilitate the data team and/or application manager 304 making a geographic location-agnostic (and as will be made more apparent in further examples industry-agnostic and organization policy-agnostic) selection of a type of regulation (e.g., local, industry, organization, etc.) regulation to be applied to an application deployment and then relying on the intelligence of data compliance process 328 to compute the specific regulations applicable to a deployment. As such, a same selection of a type of regulation may be utilized to deploy instances of the application across a variety of compliance zones, industries, organizations, etc.

To this end, data compliance regulation repository 322 may provide a repository of data handling rules. The data handling rules stored in data compliance regulation repository 322 may be consumed by a data team and/or application manager 304 as a service (aaS). Data compliance regulation repository 322 may support the input, expression, collection, approval, visualization, and use of data compliance polices covering various categories of rules. For example, data compliance regulation repository 322 may support two categories of rules such as first category, industry regulations 324, including rules specific to an industry using an application (e.g., HIPAA for healthcare application managing patients' data in the U.S., etc.) and a second category, national regulations 330, including rules and/or governmental regulations that apply to specific geographic locations such as at state/province level, national or multi-national level, etc. (e.g., the California Consumer Privacy Act applying in California, U.S.A., etc.).

In various embodiments, an organization may leverage the service of data compliance regulation repository 322 to provide a data team and/or application manager 304 access to the rules already available in the data compliance regulation repository 322. The rules may cover regulations across several industries and/or geographical regions out-of-the-box.

The organization may simply select and/or otherwise indicate the target geographic regions (e.g., state, country, multi-national area, etc.), the industry using the application if needed, and/or any other compliance rules that might be required at the organizational level (e.g., an organization's compliance rules 308 including rules regarding retaining, processing, storing, accessing, etc. confidential information or other data that may or may not be regulated by laws). Compliance engine 306 may utilize these selections to enforce data compliance for an application. Data compliance enforcement by compliance engine 306 may include applying the specified data compliance rules to data access requests, data storage and retainment policies, data processing requirements, etc. both at application deployment and application execution time.

Different rules may apply to different categories of data. In order to differentially apply rules to particular categories of data, a mechanism to discriminate among the categories of data in the application may be utilized. As such, the data may be classified and/or labeled. Previously, weak scaling and static data discovery techniques, data categorization, classification, and tagging have been implemented to identify data. However, as described above, a DCaC model may utilize embedded application program code annotations and associations to simplifies data compliance tasks in a manner that is scalable and capable to adapt to changing laws and other data sovereignty requirements.

With DCaC, application developers may automatically annotate the application code. For example, API calls, classes, methods and the resulting data may all be annotated at code/build time. DCaC may also enable automatically rendering a data manifest for each application, thereby creating machine-readable references to categories of annotated data.

For instance, the result of the DCaC process may be an application that is composed of a set of annotated containers. Each of the annotated containers may have embedded and/or associated a machine-readable data manifest, along with an application-level data manifest (e.g., automatically created as the composition of the individual, container-level, data manifests). This additional information, embedded in the program code of the application, may then be leveraged by a data team and/or application manager 304 to create, using compliance engine 306, automated associations and protection bindings between such annotations (e.g., the metadata provided by the application containers) and specific categories of sensitive data handled in association with the annotated portions of the application program code.

More specifically, compliance engine 306 may associate each category of annotated data (e.g., “protected-type-1”) within a container to a specific category of sensitive data (e.g., “Customer PII”). Likewise, if a container handles data annotated as “protected-type-2,” this might be associated to another category of sensitive data (e.g., “Employee PII”). As described in greater detail above, compliance engine 306 along with SDKs and tooling for application developers may provide a set of predefined protected data types out-of-the-box, including associations by default to specific categories of sensitive data, which a data team and/or application manager 304 may accept, update, or change as they see fit. Application developers may also define their own custom data types such as custom protected data types that might not be covered by any of those available by default.

Leveraging DCaC, compliance engine 306 may utilize these annotations and their corresponding associations to enforce data compliance rules for application workloads 510 and data processing at the time of application deployment. For instance, reiterating the previous example, an application container may handle data annotated as “protected-type-1,” which for an organization may represent the “Customer PII” category of sensitive data.

If this container were needed to be deployed, for example, in the Kingdom of Saudi Arabia (KSA) (e.g., processing, retaining, accessing, etc. PII data from/concerning residents of KSA), compliance engine 306 may automatically compute the data compliance constraints that apply to PII data in the KSA. These constraints may then be used to restrict the location of the container workloads and the corresponding data processing, thereby ensuring that they comply with the PII regulations in the KSA. For instance, the Personal Data Protection Law (PDPL) in the KSA may generally prohibit the processing of personal data of KSA residents outside of the KSA. Hence, compliance engine 306 may automatically compute that any application workload 510 processing PII of residents of the KSA should run in infrastructure located with the KSA to comply with the laws.

Similarly, if the same application container were needed to be deployed in British Columbia (BC), Canada (e.g., processing, retaining, accessing, etc. PII data from/concerning residents of BC, Canada), compliance engine 306 may automatically compute the data handling constraints that apply to PII in BC, Canada. Accordingly, compliance engine 306 may restrict the location of the container workloads and their corresponding data processing according to the applicable regulations for data handling in BC, Canada.

As such, compliance engine 306 may leverage DCaC to automatically abstract and transparently handle intricacies of data sovereignty regulations and legal obligations. Hence, DCaC may be leveraged to facilitate compliance engine 306 providing a set of reusable methods for identifying, computing, and applying data compliance restrictions applicable to categories of sensitive data used by an application, while allowing application developers and data teams and/or application managers 304 to remain oblivious to the intricacies of data sovereignty regulations and legal obligations if they so choose. Therefore, utilizing DCaC may provide a future-proof approach to compliance, since organizations using compliance engine 306 may quickly adjust to current or future rulesets, geographic location-by-geographic location, industry-by-industry, etc. simply by leveraging the data compliance regulation repository 322 and/or updating their organization's compliance rules 308. In various embodiments, data compliance process 328 may also be utilized with non-containerized applications, as the techniques described herein are applicable outside of the containerized examples.

If the application deployment performed by workload engines 332 is successful, then several application workloads 510 may be spun up running in various clusters (e.g., in a set of K8s or K3s clusters), supported by heterogenous public and/or private multi-cloud and/or edge infrastructure 334.

Workload engines 332 may consider a variety of elements 504 in configuring a deployment of an application. For example, workload engines 332 may configure a deployment of an application workload 510 based on a set of service level objectives (SLOs), such as performance or cost-related constraints. Further, workload engines 332 may configure a deployment of an application workload 510 based on application parameters and dependencies. Furthermore, workload engines 332 may configure a deployment of an application workload 510 based on filtering functions, including the explicit or implicit selection of specific infrastructure and/or locations among those available for the application deployment.

In addition to these considerations, compliance engine 306 may introduce additional deployment controls focused on data compliance. For instance, compliance engine 306 may programmatically process and amalgamate various data compliance obligations and rules, including but not limited to, geographic location specific regulations such as at state/province level, national or multi-national level, etc. data handling regulations, industry specific regulations, and/or rules that may be specifically defined by an organization (e.g., a company policy on how to restrict confidential data, etc.). Based on these various data compliance obligations and rules, compliance engine 306 may inferentially compute the set of data compliance constraints to be used to control the location of application workloads 510 and the corresponding data processing across cloud and edge infrastructures 334 at deploy time.

Compliance engine 306 may also obtain, process, and verify a set of trusted attestations. The attestations may certify the identity and/or geographic location of the infrastructure nodes where application workloads 510 may be instantiated. In various embodiments, such attestations may be obtained from a set of trust anchors 508 either at pre-deploy or deploy time.

Compliance engine 306 may automatically create deployment manifest 502. Deployment manifest 502 may capture and/or specify the requirements and constraints (e.g., application SLOs, application parameters and dependencies, selected geographic locations, data compliance constraints, trusted attestations, etc.). Deployment manifest 502 may be utilized by compliance engine 306 to exercise control, through the set of workload engines 332, to restrict the location of application workloads 510 across different geographical locations, multi-cloud, and edge environments in accordance with the inferred data compliance constraints and/or the existence of verifiable attestations of the application workload 510 locations at deploy time. Compliance engine 306 may also collect additional metadata 506, such as attestable workload identifiers (e.g., using secure production identity framework for everyone (SPIFFE)/SPIFFE runtime environment (SPIRE), etc.), once the application workloads 510 are deployed in cloud and edge infrastructures 334. Compliance engine 306 may bind the collected IDs of those deployed application workloads 510 to IDs of the attested infrastructure nodes where they run.

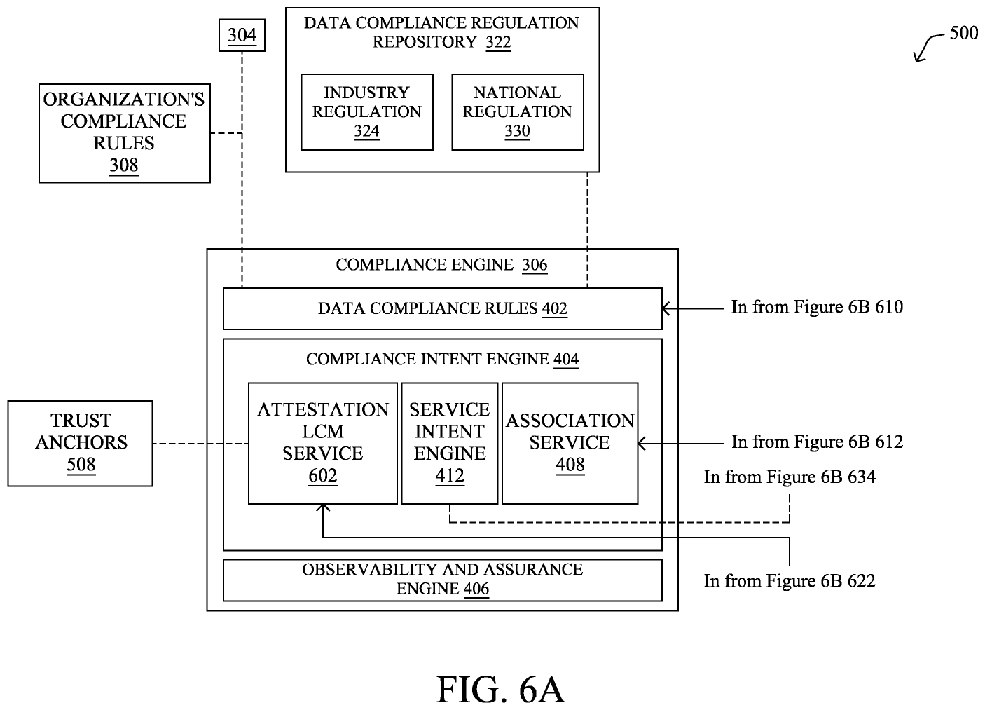

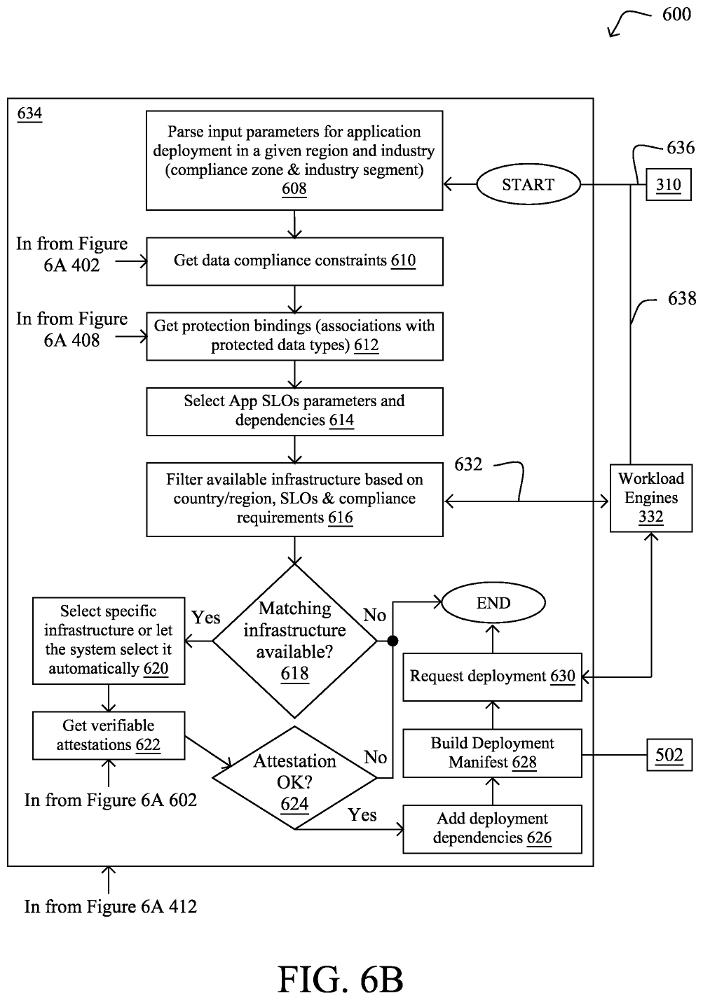

FIGS. 6A-6B illustrate an example architecture 600 for constraining application workloads using data compliance rules, in accordance with one or more embodiments described herein. Architecture 600 may include compliance engine 306. Compliance engine 306 may process a set of data compliance rules, compute the data compliance constraints from those rules that apply for a given industry, geographical region, etc. and/or for a given category of sensitive data handled by the application workloads, and use verifiable attestations to control and restrict the deployment of the application workloads at least at pre-deploy and deploy time.

Compliance engine 306 may comprise a set of modules. The modules may include machine-readable instructions executable by a processor to perform various functions. For example, compliance engine 306 may include compliance intent engine 404. Compliance intent engine 404 may include a module such as service intent engine 412. Service intent engine 412 may include a set of machine-readable instructions executable by a processor to perform application deployment process 634.

In application deployment process 634, compliance engine 306 may operate according to either push model 636 or pull model 638. For instance, application deployment process 634 may start in response to being triggered by SRE/IT team 310 (e.g., push model 636) or in response to a request being issued by workload engines 332 (e.g., pull model 638).

In both models, a next step may involve, at 608, parsing of a request for deploying an application. For example, deployment request elements such as an application ID, a corresponding geographical region (e.g., state/province level, national or multi-national level, etc.) where the application will operate, an industry segment within which the application will operate, etc. may be parsed by compliance engine 306. These elements may be utilized by the service intent engine 412 to identify the application, the data compliance zone, and the industry segment applicable to the request.

At 610 of application deployment process 634, service intent engine 412 may request the computation of the data compliance constraints that apply for this specific deployment of the application. Such constraints may be computed and provided by data compliance rules module 402. The data compliance rules module 402 may, in some examples, be a part or component of compliance engine 306. That is, data compliance rules module 402 component of the compliance engine 306 may be executable to perform the computation of the data compliance constraints that apply for this specific deployment of the application.

For instance, data compliance rules module 402 may utilize rules (e.g., organization's compliance rules 308) defined by an organization using/deploying the application. For example, a data team and/or application manager 304 may create organization's compliance rules 308 (e.g., such as the data compliance rules illustrated in Table 2) beforehand (e.g., in day −1 relative to executing application deployment process 634) so that the rules are available and ready to use before the trigger initiating application deployment process 634.

TABLE 2
PREDEFINED DATA COMPLIANCE RULES FOR CATEGORIES OF SENSITIVE
DATA IN “APP1” FOR A SPECIFIC COMPLIANCE ZONE

| | | DATA | DATA | DATA |
|---|---|---|---|---|
| | | PROCESSING | STORAGE | ACCESS/VIEW |
| (subject to | Researcher | Local | Local | Local |
| personal data | PII | Regulation | Regulation | Regulation |
| protection laws) | | | | |
| → | | | | |
| (subject to | Patient | Local & | Local & | Local & |
| industry- | Analysis | Industry | Industry | Industry |
| specific | Results | Regulation | Regulation | Regulation |
| regulation) → | | | | |
| (subject to | Study - | On prem - L1 | On prem - L1 | On prem - L1 |
| organization's | Confidential | | | |
| data compliance | Class 1 | | | |
| rules) → | | | | |
| | . . . | . . . | . . . | . . . |

For example, the rules in Table 2 may apply for a new application deployment for “App 1” in Compliance Zone 1.

The computations performed by data compliance rules module 402 may be supported by a data compliance regulation module and/or service which may provide access to data compliance regulation repository 322. Data compliance regulation repository 322 may serve as a repository of industry regulations 324, and geographical region regulations (e.g., state/province level, national or multi-national level, etc.) such as national regulations 330. The regulations may be stored within data compliance regulation repository 322 in a machine-readable format that can be consumed and used programmatically.

Data compliance rules module 402 may utilize organization's compliance rules 308, data compliance regulation repository 322, and/or the application ID, corresponding geographical region where the application will operate, industry segment within which the application will operate, etc., as parsed by compliance engine 306, in order to compute the set of data compliance constraints that apply for an application (e.g., application “App1”) in the compliance zone (e.g., “Compliance Zone 1”) selected for the application deployment. Data compliance rules module 402 may return the resulting computed set of data compliance constraints to service intent engine 412 (e.g., to application deployment process 634 in 610).

At 612 of application deployment process 634, service intent engine 412 may proceed to obtain the bindings (e.g., protection bindings) between the categories of sensitive data included in organization's compliance rules 308 and the corresponding annotations of protected data types embedded in the program code of the application (e.g., embedded in the program code of application containers). Those protection bindings may map the set of protected data types referenced in the application data manifest to the categories of sensitive data included in organization's compliance rules 308. Association service 408 of compliance engine 306 may manage and store the protection bindings.

For instance, the categories of sensitive data “Researcher PII,” “Patient Analysis Results,” and “Study-Confidential Class 1” specified in organization's compliance rules 308 may be associated to annotations within the program code of the application labeling protected data types as, for example, “protected-type-2,” “protected-type-23,” and “custom-type-1,” respectively. These associations may be defined by a data team and/or application manager 304 beforehand and may be consumable through association service 408.

Service intent engine 412 may link the resulting computed constraints for the different categories of sensitive data, yielded by data compliance rules module 402 at 610, to the corresponding associations yielded by association service 408. As a result, the data compliance constraints, obtained at 610, may be bound and/or apply to the annotations in the program code of the application. For example, the deployment of an application container with embedded annotations involving “protected-type-23,” will be treated as the category of sensitive data “Patient Analysis Results,” and therefore the corresponding workloads will be restricted by application deployment process 634 to locations complaint with the constraints yielded by data compliance rules module 402 for the rule “Local & Industry Regulation” specified in organization's compliance rules 308 (e.g., in the example illustrated in Table 2).

At 614 of application deployment process 634, a set of application requirements may be selected. For example, a set of application SLOs, as well as other potential parameters and dependencies (e.g., the need to deploy a MySQL database) may be selected.

At 616 of application deployment process 634, the infrastructure available to deploy application workloads may be filtered. For example, service intent engine 412 may apply a filter to all the infrastructure available to deploy application workloads in order to exclude from consideration for deployment any infrastructure that does not comply with, the selected compliance zone determined at 608, the compliance constraints obtained at 610 for the categories of sensitive data determined at 612 to be associated with the workloads, and/or the application SLOs, application parameters, application dependencies, etc. selected at 614.

Therefore, the available infrastructure may be filtered to identify resources that can host the application workloads within the available infrastructures, based on the selected compliance zone, the computed compliance constraints, and/or the application SLOs, application parameters, application dependencies, etc. Such filtering may apply across different cloud, edge, or infrastructure providers, including resources managed by the organization itself (e.g., the “on prem-L1” specified in Table 2), within the compliance zone selected). This filtering may be based on knowledge of compliant public cloud zones, compliant public edge zones, as well as private cloud and edge infrastructures. Such knowledge may be obtained through configuration performed by SRE/IT team 310 in compliance engine 306 beforehand and/or obtained through the infrastructure providers and/or even from the workload engines 332 themselves (e.g., via communication 632).

At 618 of application deployment process 634, a determination may be made whether, after the filtering performed at 616, any compliant infrastructure matching the requirements is available. In the event that one or more compliant resources match the requirements (e.g., “YES”), the particular compliant infrastructure where the application workload will be deployed may be selected at 620. In various embodiments, the particular complaint infrastructure may be explicitly selected by someone managing the process (e.g., SRE/IT team 310, a data team and/or application manager 304, etc.) and/or service intent engine 412 may automatically select it from the identified available compliant infrastructure. Conversely, in the event that one or more compliant resources do not match the requirements (e.g., “NO”), the application deployment process 634 may end. In some examples, this may include returning an error message or other indication that no matching compliant infrastructure was identified within a pool of available infrastructure.

At 622 of application deployment process 634, verifiable attestations may be obtained for the selected complaint infrastructure nodes. Verifiable attestations may be utilized when service intent engine 412 requires proof of the geographic location of the selected infrastructure nodes where the workloads are to be deployed.

To this end, compliance intent engine 404 may include an attestation lifecycle management (LCM) service 602. Attestation LCM service 602 may interface with trust anchors 508 that may provide attestations vouching for or certifying the geographic location of the selected infrastructure of which they represent and/or control.

Various types of trust anchors 508 may be utilized. For instance, trust anchors 508 may include Certificate Authorities (CAs), trusted registries implementing World Wide Web Consortium (W3C) verifiable credentials, Gaia-X verifiable labels, trusted cloud, edge, or other infrastructure providers that may attest to the location of their infrastructure nodes, etc.

The attestations may operate in an open-loop and/or closed-loop mode. In an open-loop mode, the proof of location provided by trust anchors 508 may be sufficient for application deployment process 634 to proceed with the next steps involved in building a workload deployment request.

In a closed-loop mode, compliance intent engine 404 may utilize the proof obtained from a trust anchor 508 to verify directly with the subject infrastructure node. In some cases, compliance intent engine 404 may not have direct access to the infrastructure nodes, so verification with the subject infrastructure node may be instrumented through workload engine 332 or another trusted proxy. The verification may, in some examples, be instrumented as a remote attestation process, two-factor authentication (2FA) process, multi-factor authentication (MFA), and/or combinations thereof.

The proofs issued by trust anchors 508 may comprise elements such as GPS coordinates, IP and MAC addresses, hashes, etc. In some examples, data residency may be additionally or alternatively constrained to environmental regulations such as zero/low carbon objectives of an organization. In such examples, the attestations from the trust anchors 508 may alternatively or additionally require proof of an environmental metric related to the regulation, such as proof of carbon footprint of an infrastructure node. In various embodiments, the infrastructure nodes to host the application workload and/or the data consumers may be static and/or confined within a geographic location.

At 624 of application deployment process 634, a determination may be made whether the attestations were obtained at 622 and/or whether the obtained attestations were successfully verified. The absence of such proofs (e.g., “NO”) may prevent the creation of any workload placement request by application deployment process 634 and cause application deployment process 634 to end. In some examples, this may include returning an error message or other indication that no matching compliant infrastructure was identified within a pool of available infrastructure. Conversely, if such proofs are obtained (e.g., “YES”), then application deployment process 634 may proceed to 626.

At 626, application deployment process 634 may include adding, responsive to a successful verification of the attestations for the nodes selected to host the workloads, other dependencies that might be required before, or together, with the application deployment. For instance, the need to a have an Istio control plane running, or deploy Envoy sidecar proxies, etc. In addition, as mentioned above, attestation LCM service 602 may collect attestable workload identifiers (e.g., using SPIFFE/SPIRE) and bind those workload IDs to IDs of attested infrastructure (e.g., the IDs of the nodes hosting the workloads, where in this pre-deployment phase, the workload IDs might be those linked to control plane workloads, such as Istio-specific, Envoy-specific, or Kubernetes-specific workloads).

At 628, application deployment process 634 may include automatically rendering deployment manifest 502. Deployment manifest 502 may capture and/or specify the computed data compliance constraints, the selected compliance zone, and/or the application SLOs, application parameters, application dependencies, etc. The contents of deployment manifest may be processed programmatically by workload engine 332. In embodiments where the deployment involves more than one workload engine 332 (e.g., a multi-cloud deployment, or could-to-edge deployment, etc.), one deployment manifest 502 for each workload engine 332 may be generated.

At 630 of application deployment process 634 service intent engine 412 may generate a declarative workload placement request to a set of workload engines 332 (e.g., push model), or respond with the set of compliance constraints associated to a workload placement request from the workload engines 332 (e.g., pull model). Therefore, in some examples, if step 630 is reached, then process 634 may end when, at 630, a response is received from workload engines 332 regarding the deployment made (e.g., successfully executed or not). If the deployment process is successful, a set of clusters (e.g., a set of K8 clusters) may be spun up across different cloud and edge infrastructures as part of the successful application workload deployment. These clusters may be composed of a set of Pods, and specific services within each cluster may register with observability and assurance engine 406, which may also be part of compliance engine 306. Observability and assurance engine 406 may be utilized to provide observability and data geofencing functions at runtime.

To summarize, architecture 600 may be utilized to amalgamate various data sovereignty obligations and compliance rules at pre-deploy time, including, but not limited to: state/province, national, multinational, etc., data protection regulations; industry specific regulations; and rules that me be specifically defined by an organization (e.g., how to handle confidential data). In addition, architecture 600 may be utilized to process various data compliance rules programmatically and use that at pre-deploy time and to compute the set of data handling constraints that apply for a given application deployment in a given compliance zone, including industry-specific and organization-specific constraints at pre-deploy time. Architecture 600 may be utilized to obtain a set of protection bindings mapping a set of protected data types associated to the services (e.g., workloads) that compose the application to the data compliance rules defined at pre-deploy time. At deploy time, Architecture 600 may be utilized to filter the available infrastructure resources based on the data compliance constraints inferred, as well as SLOs and other parameters to obtain a compliant infrastructure where workloads may be deployed. Architecture 600 may be utilized to obtain and validate a set of verifiable attestations either at pre-deploy time or deploy time (e.g., including infrastructure identifiers, proof of geographical location, and/or carbon footprint), as well as the potential bindings between attestable workload identifiers and attestable infrastructure node identifiers at deploy time. Further, architecture 600 may be utilized to automatically generate a deployment manifest to instrument control on the geographical location of the workloads across different geographical locations, multi-cloud, and/or edge environments, restricted to the data compliance constraints computed at deploy time. Furthermore, architecture 600 may be utilized to select and/or exercise control on the geographical location of application workloads and the corresponding data processing across different geographical locations, multi-cloud, and edge environments, constrained to the defined data compliance rules, the existence of verifiable attestations (e.g., including the infrastructure location and/or its carbon footprint), and/or other relevant SLOs at deploy time.

In this manner, architecture 600 may leverage the DCaC model, including annotated application code and resulting data, to construct a collaborative environment where organizations developing applications and services across a variety of industries (e.g., healthcare, finance, energy, etc. as well as SaaS providers can proactively assist their customers (e.g., a data team and/or application manager 304, organizations, etc.) through automation and controls simplifying data compliance collaboration. In addition, application developers and/or DevSecOps teams may utilize architecture 600 while developing a new application or refactoring an existing one (e.g., refactoring to cloud-native/edge-native environments) to allow for automated data compliance collaboration.

Specifically, architecture 600 may be operable to enable infrastructure-neutral data compliance controls allowing organizations to reduce the complexity, risks, and costs of dealing with data compliance (e.g., from multi-cloud to edge). Leveraging the metadata of the DCaC model within architecture 600 may also assure and future-proof residency/compliancy for applications used by the organization along with providing a mechanism for observability of data compliance without complex and extensive re-engineering efforts. In various embodiments, architecture 600 may be utilized to achieve these functions at least during the testing, staging, and production phases of an application.

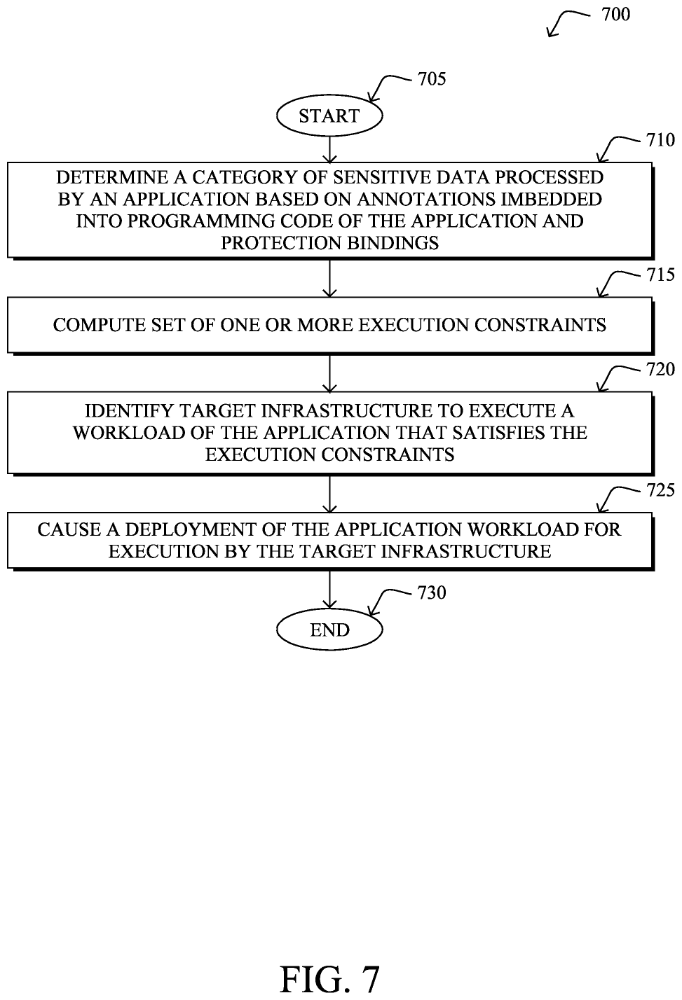

FIG. 7 illustrates an example simplified procedure (e.g., a method) for constraining application workloads using data compliance rules, in accordance with one or more embodiments described herein. For example, a non-generic, specifically configured device (e.g., device 200), may perform procedure 700 by executing stored instructions (e.g., data compliance process 248). The procedure 700 may start at step 705, and continues to step 710, where, as described in greater detail above, a device may determine a category of sensitive data processed by an application, based on annotations embedded into programming code of the application and protection bindings, which associate the category of sensitive data with one or more data types used by the application. The protection bindings may be managed outside of the programming code.

At step 715, as detailed above, the device may compute, based on One or more data compliance constraints for the category of sensitive data, a set of one or more execution constraints for the application. In various embodiments, the one or more data compliance constraints may restrict the workload from being executed in a particular geographic location when it processes data that matches the category of sensitive data. The set of one or more execution constraints may be automatically computed based on a repository of industrial regulations, governmental regulations, or organizational regulations. The set of one or more execution constraints may be associated with the category of sensitive data.

At step 720, the device may identify target infrastructure to execute a workload of the application that satisfies the set of one or more execution constraints for the application.

At step 725, as detailed above, the device may cause a deployment of the workload of the application for execution by the target infrastructure. In some examples, the workload of the application may be deployed for execution by the target infrastructure subject to obtaining, by the device, an attestation of a geographic location of the target infrastructure. The attestation may be obtained from a set of trust anchors. The attestation for the target infrastructure may be cross-checked with the target infrastructure. In various embodiments, causing the deployment of the workload of the application for execution by the target infrastructure may further include generating, by the device, a deployment manifest of the workload that specifies a set of requirements for the application and the set of one or more execution constraints and communicating the deployment manifest to a manager of the target infrastructure (e.g., the corresponding workload engine).

In addition, a workload identifier for the workload may be collected after its deployment. The workload identifier may be bound to an identifier of the target infrastructure where the workload is deployed. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, may leverage the DCaC model to generate application workloads that satisfy various data compliance requirements and ensure data sovereignty in an automate manner at pre-deploy and deploy time. More specifically, these techniques may introduce automated and attestable control on application workload placement (e.g., as part of a service mesh) subject to various data sovereignty and compliance rules, which may apply across different geographical locations, multi-cloud, and edge environments. All of this may be accomplished while application developers and/or operators are largely allowed to remain oblivious to the specificities and intricacies of the different data compliance regulations across the different industries, geographical locations, and/or organizations.

While there have been shown and described illustrative embodiments that facilitate a DCaC-based approach to constraining application workloads using data compliance rules, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
determining, by a device, a category of sensitive data processed by an application, based on annotations embedded into programming code of the application and based upon protection bindings, which associate the category of sensitive data with one or more data types used by the application;
computing, by the device and based on one or more data compliance constraints for the category of sensitive data, a set of one or more execution constraints for the application;
identifying, by the device, target infrastructure to execute a workload of the application that satisfies the set of one or more execution constraints; and
causing, by the device, a deployment of the workload of the application for execution by the target infrastructure.

2. The method as in claim 1, wherein the one or more data compliance constraints restrict the workload from being executed in a particular geographic location when it processes data that matches the category of sensitive data.

3. The method as in claim 1, wherein causing, by the device, the deployment of the workload of the application for execution by the target infrastructure further comprises:
generating, by the device, a deployment manifest of the workload that specifies a set of requirements for the application and the set of one or more execution constraints; and
communicating the deployment manifest to a workload engine that manages the target infrastructure.

4. The method as in claim 1, further comprising:
collecting, by the device, a workload identifier for the workload after its deployment; and
binding, by the device, the workload identifier to an identifier of the target infrastructure where the workload is deployed.

5. The method as in claim 1, wherein causing, by the device, the deployment of the workload of the application for execution by the target infrastructure is performed subject to obtaining, by the device, attestation of a geographic location of the target infrastructure.

6. The method as in claim 5, wherein the attestation is obtained from a set of trust anchors.

7. The method as in claim 5, further comprising:
cross-checking, by the device, the attestation with the target infrastructure.

8. The method as in claim 1, wherein the set of one or more execution constraints is automatically computed based on a repository of industrial regulations, governmental regulations, or organizational regulations.

9. The method as in claim 1, further comprising:
associating, by the device, the set of one or more execution constraints with the category of sensitive data.

10. The method as in claim 1, wherein the protection bindings are managed outside of the programming code.

11. An apparatus, comprising:
one or more network interfaces;
a processor coupled to the one or more network interfaces and configured to execute one or more processes; and
a memory configured to store a process that is executable by the processor, the process when executed configured to:
determine a category of sensitive data processed by an application, based on annotations embedded into programming code of the application and based upon protection bindings, which associate the category of sensitive data with one or more data types used by the application;
compute, based on one or more data compliance constraints for the category of sensitive data, a set of one or more execution constraints for the application;
identify target infrastructure to execute a workload of the application that satisfies the set of one or more execution constraints; and
cause a deployment of the workload of the application for execution by the target infrastructure.

12. The apparatus as in claim 11, wherein the one or more data compliance constraints restrict the workload from being executed in a particular geographic location when it processes data that matches the category of sensitive data.

13. The apparatus as in claim 11, wherein the process when executed is further configured to:
generate a deployment manifest of the workload that specifies a set of requirements for the application and the set of one or more execution constraints; and
communicate the deployment manifest to a workload engine that manages the target infrastructure.

14. The apparatus as in claim 11, wherein the process when executed is further configured to:
collect a workload identifier for the workload after its deployment; and
bind the workload identifier to an identifier of the target infrastructure where the workload is deployed.

15. The apparatus as in claim 11, wherein the process configured to cause the deployment of the workload of the application for execution by the target infrastructure is executed subject to obtaining attestation of a geographic location of the target infrastructure.

16. The apparatus as in claim 15, wherein the attestation is obtained from a set of trust anchors.

17. The apparatus as in claim 15, wherein the process when executed is further configured to:
cross-check the attestation with the target infrastructure.

18. The apparatus as in claim 11, wherein the set of one or more execution constraints is automatically computed based on a repository of industrial regulations, governmental regulations, or organizational regulations.

19. The apparatus as in claim 11, wherein the process when executed is further configured to:
associate the set of one or more execution constraints with the category of sensitive data.

20. A tangible, non-transitory, computer-readable medium storing program instructions that cause a device to execute a process comprising:
determining, by the device, a category of sensitive data processed by an application, based on annotations embedded into programming code of the application and based upon protection bindings, which associate the category of sensitive data with one or more data types used by the application;
computing, by the device and based on one or more data compliance constraints for the category of sensitive data, a set of one or more execution constraints for the application;
identifying, by the device, target infrastructure to execute a workload of the application that satisfies the set of one or more execution constraints; and
causing, by the device, a deployment of the workload of the application for execution by the target infrastructure.
